(19) United States
(12) Patent Application Publication
(10) Pub. No.: US 2018/0313143 A1
(43) Pub. Date: Nov. 1, 2018

(54) WINDOW COVERING

(71) Applicant: NIEN MADE ENTERPRISE CO., LTD., Taichung City (TW)

(72) Inventors: CHIH-YAO CHANG, Taichung City (TW); WEI-XUE YUAN, Taichung City (TW)

(21) Appl. No.: 15/691,077

(22) Filed: Aug. 30, 2017

(30) Foreign Application Priority Data
Apr. 28, 2017 (CN) 201720463798.2

(51) Int. Cl. E06B 9/322

(52) U.S. Cl. CPC E06B 9/322

(57) ABSTRACT

A window covering is disclosed, including a first rail, a second rail, and a shielding structure, wherein the second rail is movable between a high position and a low position through the driving of a cord, whereby the shielding structure can be raised and lowered. The first rail has a lifting mechanism provided therein, wherein the lifting mechanism includes a reeling device and a friction wheel. The reeling device is adapted to reel in or to release the cord, wherein the cord passes around and contacts the friction wheel. The cord provides a lateral pushing force to the friction wheel, pushing the friction wheel against a rubbed member to create friction, whereby to position the second rail accurately.

### BACKGROUND OF THE INVENTION

### 1. Technical Field

The present invention relates generally to a window covering, and more particularly to a window covering having a lifting structure which could provide a bi-directional resistance.

### 2. Description of Related Art

A conventional cordless window covering has a spring box provided in a first rail thereof, wherein the spring box includes a reeling assembly and a spring assembly. The reeling assembly releases or reels in cords along with the moving directions of a second rail, whereby the window covering can be lowered or raised. The movements of the spring assembly and the reeling assembly are related, and the spring assembly mainly includes a spiral spring. By counteracting the weight of the second rail with the rewinding force provided by the spiral spring, the second rail can stay at a required position. In this way, an area covered by the window covering can be adjusted.

However, although the rewinding force of a carefully selected spiral spring should be able to keep the second rail staying at a required position, any spiral spring may still lose its tension over time. Furthermore, the higher the second rail is raised, the more slat assembly will stack thereon, and, consequently, the downward pulling force applied to the spring box will increase. Therefore, the second rail tends to sink a little bit after reaching the required position. To overcome the drawback caused by elastic fatigue of the spiral spring, some manufacturers in the industry choose to use spiral springs which have stronger rewinding force than equilibrating force. However, due to the stronger rewinding force, such design requires the user to pull harder to lower the second rail, and therefore is inconvenient and unwieldy to use.

In addition, some energy provided by the spiral spring will be lost during the transmission through the several interacting gears arranged in the spring assembly and the reeling assembly, which will indirectly and consequently affect the accuracy in positioning the second rail. In brief, if the spiral spring provides too much pulling force, the second rail will bounce as being pulled by the spiral spring when the window covering is completely opened, i.e., when the second rail is lowered to the lowest position. In such a case, the second rail has to have sufficient weight to offset the bouncing. On the contrary, if the pulling force provided by the spiral spring is too weak to bear the total weight of the second rail and the slat assembly, the second rail and part of the slat assembly will sink when the window covering is completely closed, i.e., when the second rail is raised to the highest position.

For the above reasons, it is impractical to expect the second rail to accurately stay at a required position merely through the pulling force provided by the spiral spring. Because the weight of the second rail and the slat assembly born by the spiral spring will increase when the second rail approaches the first rail, and due to the influence caused by the several gears involved in the energy transmission, the conventional structures of a spring box simply cannot guarantee that the pulling force of the spiral spring can be balanced.

### BRIEF SUMMARY OF THE INVENTION

One aspect of the present invention is to provide a window covering, which could accurately stop a second rail thereof at a required position through an auxiliary resistance structure.

An embodiment of the present invention provides a window covering, which includes a first rail, a second rail, a shielding structure provided between the first rail and the second rail, and a lifting mechanism provided in the first rail. The lifting mechanism includes a cord, a reeling device, a friction wheel, and a rubbed member. An end of the cord is connected to the reeling device, and another end thereof is connected to the second rail. The cord passes around and contacts the friction wheel. The friction wheel matches with the rubbed member. While the first rail and the second rail are being moved to approach each other, the shielding structure is being closed, and the reeling device is reeling in the cord; while the first rail and the second rail are being moved away from each other, the shielding structure is being opened, and the reeling device is releasing the cord. When the first rail and the second rail are moved toward or away from each other, the cord drives the friction wheel to rotate, and the cord applies a lateral pushing force to the friction wheel, making the friction wheel abut against the rubbed member, whereby to create a friction between the friction wheel and the rubbed member.

In an embodiment, the friction wheel has a first friction surface, and the rubbed member has a second friction surface. The first friction surface corresponds to the second friction surface; the first friction surface and the second friction surface contact each other due to the lateral pushing force, whereby to create the friction.

In an embodiment, the rubbed member is a shaft, and the friction wheel has a shaft hole. The shaft passes through the shaft hole of the friction wheel. An outer surface of the shaft is the second friction surface, and an inner surface of the shaft hole of the friction wheel is the first friction surface.

In an embodiment, the cord drives the friction wheel and the shaft to rotate in opposite directions. When the cord applies the lateral pushing force to the friction wheel, and when a rotation of the reel drives the shaft to rotate, the first friction surface and the second friction surface contact each other and move in opposite directions, whereby to create the friction.

In an embodiment, the reeling device includes a reel, which includes a first gear portion. At least one end of the shaft has a second gear portion provided thereon, wherein the second gear portion rotates synchronously and simultaneously with the shaft. The first gear portion and the second gear portion drive each other. A rotation direction of the friction wheel and a rotation direction of the shaft driven by the cord are opposite. When the first gear portion and the second gear portion drive each other, the first friction surface of the friction wheel and the second friction surface of the shaft are moved in opposite directions, whereby to create the friction.

In an embodiment, a gear ratio of the first gear portion and the second gear portion is not 1. When the cord drives the friction wheel, a rotation speed of the first gear portion is different from a rotation speed of the second gear portion, whereby to modulate the friction.

In an embodiment, the shaft includes a post and a sleeve fitting around the post. The friction wheel fits around the sleeve; an outer surface of the sleeve is the second friction surface, and an inner surface of the shaft hole of the friction wheel is the first friction surface.

In an embodiment, the rubbed member is a recess of the first rail, and the friction wheel has a projection provided on an axial center thereof, which corresponds to and fits into the recess. An outer surface of the projection is the first friction surface, and an inner surface of the recess is the second friction surface.

In an embodiment, the first rail further includes a casing, and the lifting mechanism is provided in the casing. The rubbed member is a recess of the casing, and the friction wheel has a projection provided on an axial center thereof. An outer surface of the projection is the first friction surface, and an inner surface of the recess is the second friction surface.

In an embodiment, the shaft includes a first axial portion and a second axial portion, and an outside diameter of the first axial portion is greater than an outside diameter of the second axial portion. The shaft passes through the shaft hole of the friction wheel. An outer surface of the shaft is the second friction surface, and an inner surface of the shaft hole of the friction wheel is the first friction surface.

In an embodiment, the shaft hole of the friction wheel is a first inside diameter and a second inside diameter, and the first inside diameter is greater than the second inside diameter.

In an embodiment, a height of the shaft is greater than a height of the friction wheel, and a movement of the cord drives the friction wheel to move in an axial direction of the shaft. When the friction wheel is moved in the axial direction of the shaft from the first axial portion toward the second axial portion, a contact area between the first friction surface and the second friction surface becomes smaller, whereby to gradually reduces the friction created between the friction wheel and the shaft.

In an embodiment, a cord segment of the cord which winds a complete turn around the friction wheel includes an inward cord segment and an outward cord segment. The inward cord segment is closer to a first end of the friction wheel than the outward cord segment is. When the cord is pulled with the outward cord segment thereof, the friction wheel is driven to move toward the first end along the shaft.

In an embodiment, the friction wheel has a first diameter, and the reeling device includes a reel, which has a second diameter. The first diameter is different from the second diameter. When the cord drives the friction wheel to rotate, a rotation speed of the friction wheel is different from a rotation speed of the reel, whereby to modulate the friction.

In an embodiment, the friction wheel has a cord slot recessed into a circumferential surface of the friction wheel. The cord passes around and contacts the cord slot of the friction wheel.

In an embodiment, the reeling device includes a reel, which has a shaft. The rubbed member is another shaft, and the friction wheel fits around the another shaft; the shaft and the another shaft are separately arranged in parallel.

In an embodiment, the reeling device includes a reel, which is provided coaxially with the friction wheel.

With the above design, once the second rail is moved to a required position, the friction created between the cords and the friction wheels would help to position the second rail accurately.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the window covering of a first embodiment of the present invention, showing the window covering is raised;

FIG. 2 is a perspective view of the window covering of the first embodiment of the present invention, showing the window covering is lowered;

FIG. 3 is a perspective view of the lifting mechanism of the window covering illustrated in FIG. 1;

FIG. 4 is a sectional view of FIG. 3;

FIG. 5 is a partial enlarged view of FIG. 4;

FIG. 6 is a perspective view of one component shown in FIG. 3;

FIG. 7 is a perspective view similar to FIG. 3, showing the lifting mechanism of the window covering of a second embodiment of the present invention;

FIG. 8 is a sectional view of FIG. 7;

FIG. 9 is a perspective view of one component shown in FIG. 7;

FIG. 10 is a perspective view of the lifting mechanism of the window covering of a third embodiment of the present invention;

FIG. 11 is a top view of FIG. 10;

FIG. 12 is a side view of FIG. 10;

FIG. 13 is a perspective view of one component shown in FIG. 10;

FIG. 14 is a perspective view of the lifting mechanism of the window covering of a fourth embodiment of the present invention;

FIG. 15 is a top view of FIG. 14;

FIG. 16 is a perspective view similar to FIG. 10, showing the lifting mechanism of the window covering of a fifth embodiment of the present invention;

FIG. 17 is a top view of FIG. 16;

FIGS. 18A, 18B, 18C, and 18D are sectional views of one component shown in FIG. 16;

FIG. 19 is a side view of part of the structures shown in FIG. 16;

FIG. 20 is a partial schematic view of the lifting mechanism of the window covering of a sixth embodiment of the present invention;

FIG. 21 is a partial schematic view of the lifting mechanism of the window covering of a seventh embodiment of the present invention;

FIG. 22 is a perspective view of the lifting mechanism of the window covering of an eighth embodiment of the present invention;

FIG. 23 is a perspective view of some components shown in FIG. 22; and

FIG. 24 a sectional view showing the combination of the components shown in FIG. 22.

### DETAILED DESCRIPTION OF THE INVENTION

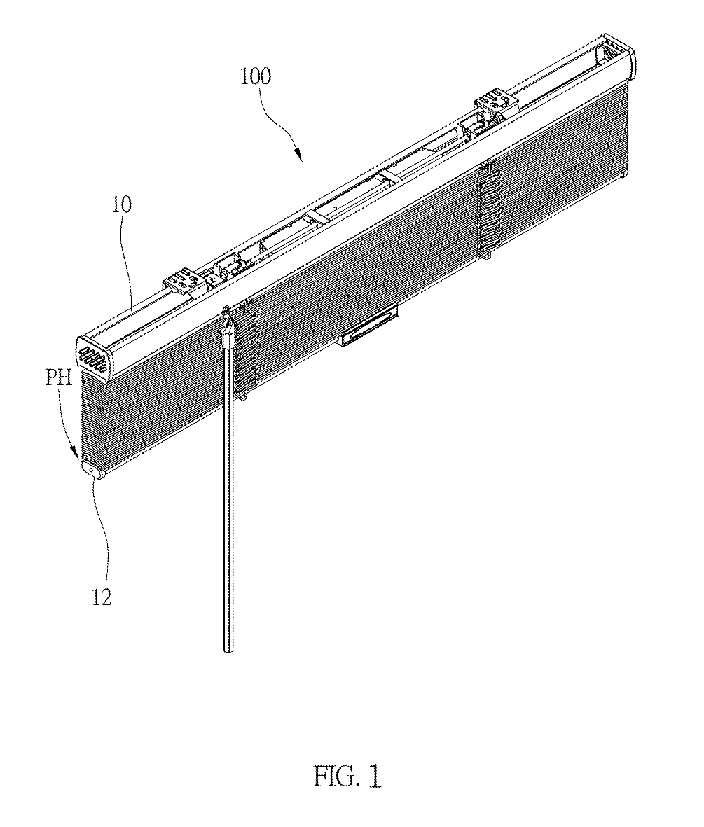

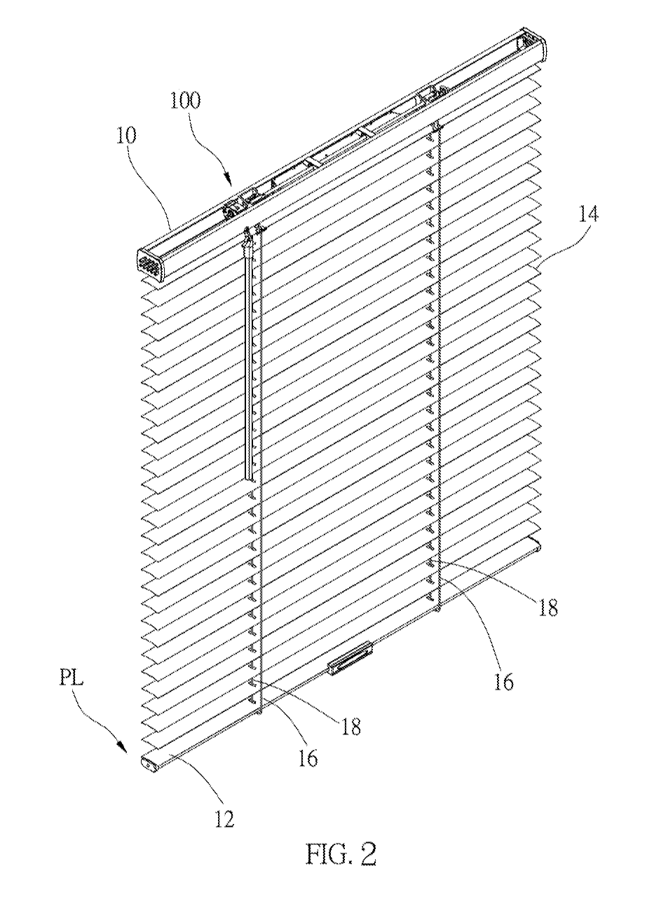

As shown in FIG. 1 and FIG. 2, a window covering 100 of a first embodiment includes a first rail 10, a second rail 12, and a shielding structure, which is composed of a plurality of slats 14. However, the specific detail of the shielding structure discussed herein is merely an example and is not a limitation of the present invention. In other embodiments, the shielding structure could be a cellular shade as well. The slats 14 are suspended in parallel between the first rail 10 and the second rail 12 through ladder tapes 16. The second rail 12 is connected to lifting cords 18 to be moved between a high position PH near the first rail 10, as shown in FIG. 1, and a low position PL away from the first rail 10, as shown in FIG. 2, whereby to open or close the shielding structure. The lifting cords 18 are adapted to raise and lower the second rail 12. In the current embodiment, the window covering 100 includes two lifting cords 18. However, the number and the arrangement of the lifting cords 18 and the ladder tapes 16 are not limitations of the present invention, and may vary depending on the size or the style of the window covering in practice.

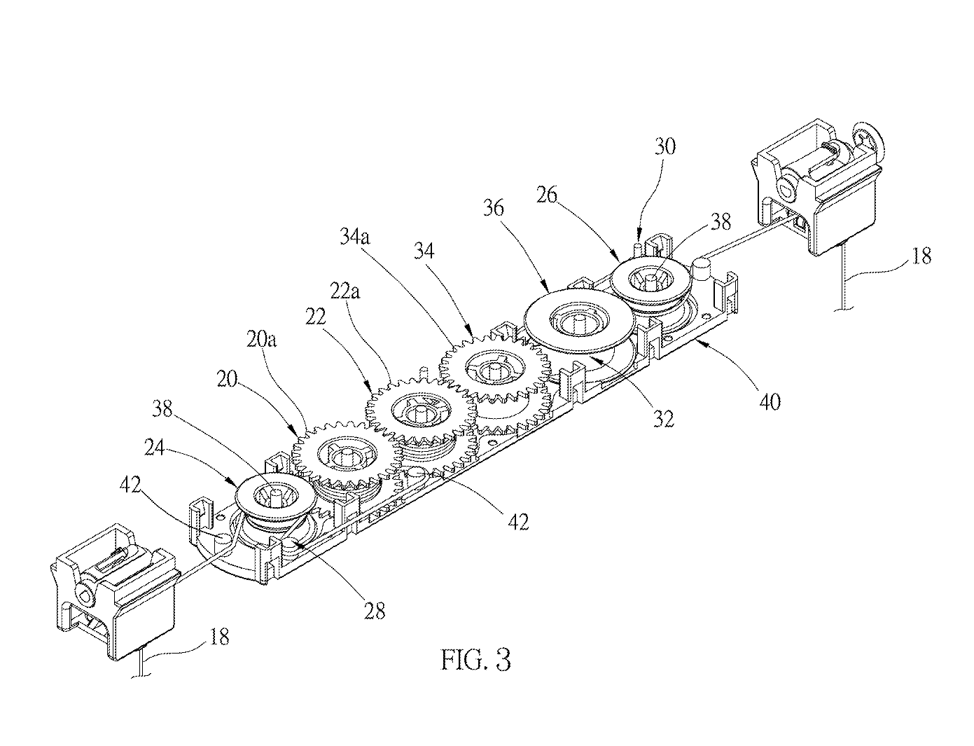

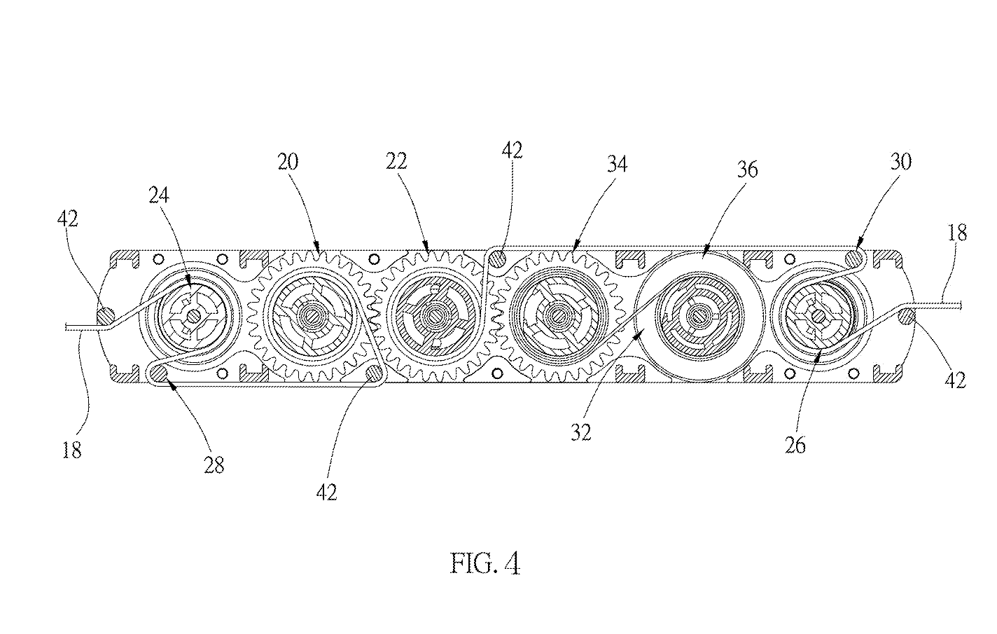

As shown in FIG. 3 and FIG. 4, the lifting mechanism of the present invention is provided in the first rail 10, and includes components such as a reeling device, a friction wheel, a direction changing member, and a prestress device. The reeling device includes two reels, each of which is adapted to reel in or release one of the lifting cords 18. The prestress device provides a pulling force to the reels, whereby the reels would rotate in a predetermined direction. In this way, the second rail 12 could stay at a required height. With the combination of the aforementioned lifting cords 18, the reels, and the prestress device, the second rail 12 could be raised and lowered without needing an exposed control cord. In other words, due to the prestress device, the window covering of the current embodiment is a cordless window covering.

In the current embodiment, the numbers of the reels, the friction wheels, and the direction changing members are all two, including a first reel 20, a second reel 22, a first friction wheel 24, a second friction wheel 26, a first direction changing member 28, and a second direction changing member 30. The prestress device includes two rotors and a spiral spring 32, wherein the rotors include a first rotor 34 and a second rotor 36, and two ends of the spiral spring 32 are respectively connected to the first rotor 34 and the second rotor 36. Each component among the first reel 20, the second reel 22, the first friction wheel 24, the second friction wheel 26, the first rotor 34, and the second rotor 36 respectively fits around a corresponding cylindrical shaft 38, and is therefore provided on a base 40 in a rotatable manner.

A body of each of the first reel 20 and the second reel 22 is respectively connected to an end of one of the lifting cords 18, and another end of each of the lifting cords 18 is connected to the second rail 12. Each of the first reel 20 and the second reel 22 respectively has two first gear portions 20a, 22a respectively provided on a top and a bottom thereof, wherein each of the first gear portions 20a, 22a is a toothed disc. Furthermore, the first gear portions 20a of the first reel 20 mesh with the first gear portions 22a of the second reel 22. The first rotor 34 has two third gear portions 34a respectively provided on a top and a bottom thereof, wherein the third gear portions 34a are toothed discs. The third gear portions 34a mesh with the first gear portions 22a of the second reel 22. Whereby, the first reel 20, the second reel 22, and the first rotor 34 are linked together. However, the toothed discs of the first reel 20, the second reel 22, and the first rotor 34 are not necessary to be provided on the tops and the bottoms; other positions would be also plausible, as long as the toothed discs can mesh with each other for transmission purposes. In addition, the sequence of arrangement of the first reel, the second reel, and the first rotor is not limited to the way illustrated in FIG. 3; different sequences of arrangements are also acceptable as long as the same effect of transmission can be achieved.

The first rotor 34 and the second rotor 36 are connected through an S-shaped winding of the spiral spring 32, and therefore the numbers of the windings around the first rotor 34 and the second rotor 36 could be changed when the rotors 34, 36 change the rotation directions. The situation illustrated in FIG. 3 to FIG. 5 is when the second rail 12 is close to the low position PL. At this time, most parts of the lifting cords 18 are respectively released from the first reel 20 and the second reel 22, and most parts of the spiral spring 32 wind around the first rotor 34. On the contrary, when the second rail 12 is close to the high position PH, most parts of the lifting cords 18 are wound up around the first reel 20 and the second reel 22 in an overlapping manner, and most parts of the spiral spring 32 wind around the second rotor 36 instead, which is not shown in the drawings. The spiral spring 32 is carefully selected through precise measurements to ensure that the pulling force provided by the spiral spring 32 is suitable for the window covering to stop the second rail 12 at a required position.

In the current embodiment, the first friction wheel 24 is adjacent to the first reel 20, and the second friction wheel 26 is adjacent to the second rotor 36; the first direction changing member 28 is adjacent to the first friction wheel 24 but away from the first reel 20, and the second direction changing member 30 is adjacent to the second friction wheel 26 but away from the second rotor 36. Each of the lifting cords 18 passes through and contacts one of the direction changing members 28, 30 and one of the friction wheels 24, 25. In other words, the direction changing members 28, 30 and the friction wheels 24, 25 changes the winding route of the lifting cords 18. If necessary, at least one direction changing member 42 can be further provided to change the winding route of one of the lifting cords 18. The aforementioned direction changing members 28, 30, 42 are cylindrical rods.

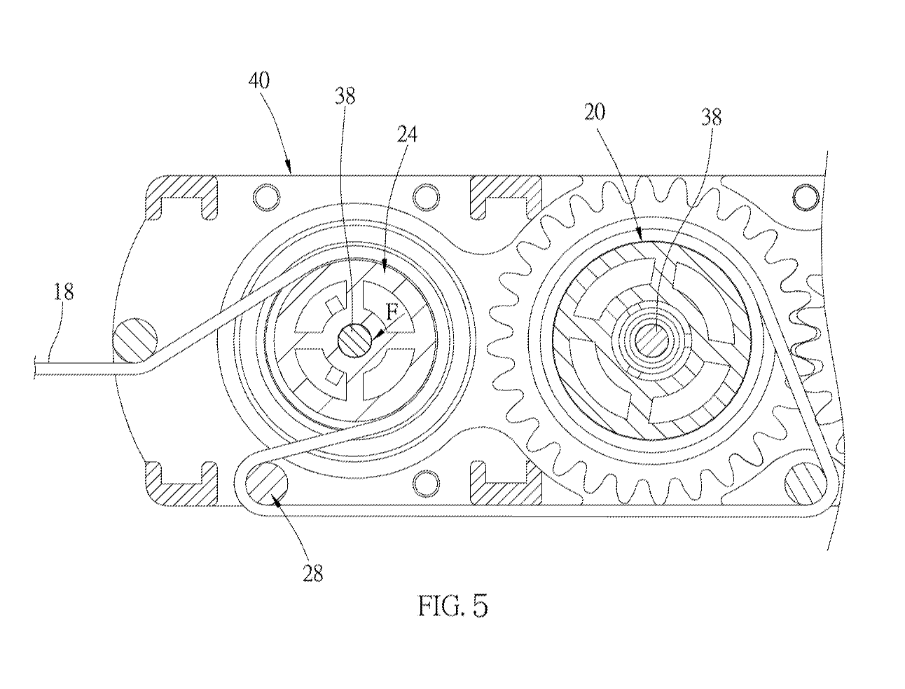

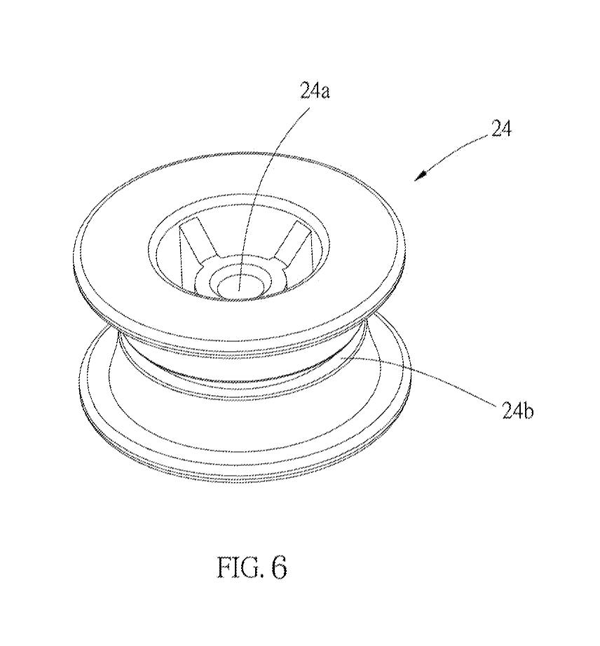

The lifting cords 18 are always taut for bearing the weight of the second rail 12 and the slats 14 stacked thereon. By providing the direction changing members 28, 30, 42 at the aforementioned specific positions, each of the first friction wheel 24 and the second friction wheel 26 respectively contacts one of the lifting cords 18 with at least half of a wheel surface thereof. As a result, each of the lifting cords 18 respectively applies a lateral pushing force F to the first friction wheel 24 or the second friction wheel 26. The lateral pushing force F would urge the friction wheels 24, 26 to abut against the corresponding shafts 38. More specifically, the shafts 38 corresponding to the friction wheels 24, 26 constitute the rubbed members defined in the present invention. Each of the friction wheels 24, 26 has a first friction surface, which corresponds to a second friction surface of the corresponding rubbed member. The first friction wheel 24 shown in FIG. 5 and FIG. 6 is used as an example for illustration. The aforementioned lateral pushing force F would urge the first friction wheel 24 to tightly abut against an outer surface (i.e., the second friction surface) of the shaft 38 with part of the wall (i.e., the first friction surface) of a shaft hole 24a thereof. No matter the second rail 12 is lowered to pull out the lifting cords 18 from the reels 20, 22, or is raised to reel in the lifting cords 18 by the reels 20, 22 due to the rewinding force provided by the spiral spring 32, the aforementioned lateral pushing force F would create contact friction between the first friction surface of each of the friction wheels 24, 26 and the second friction surface of the corresponding shaft 38. With the contact friction and the pulling force provided by the spiral spring 32, the second rail 12 could accurately stay at a required position. Whereby, the problem that the second rail 12 may sink could be improved.

In the current embodiment, each of the first friction wheel 24 and the second friction wheel 26 has a cord slot provided around a cylindrical body thereof, i.e., the cord slot recessed into a circumferential surface of the cylindrical body. Herein, the cord slot 24b of the first friction wheel 24 is taken as an example. The cord slot 24b receives part of one of the lifting cords 18 therein, whereby to guide said part of said lifting cord 18 to turn at the first friction wheel 24. In addition to stabilizing the position of the corresponding lifting cord 18, the cord slot 24b would also create higher friction, for slot walls of the cord slot 24b enlarges a contact area for the corresponding lifting cord 18. Of course, if the friction created through the abutting between the friction wheels 24, 26 and the shafts 38 is, with the help of the pulling force provided by the spiral spring 32, already sufficient to properly and accurately position the second rail 12, the cord slots 24b can be omitted in other embodiments.

In the aforementioned embodiment, the objective of properly positioning the second rail 12 is achieved by exerting the lateral pushing force to the friction wheels 24, 26 through the lifting cords 18, whereby to create the friction between the friction wheels and the corresponding shafts 38. However, this is not a limitation for designs utilizing friction. In the window covering of each embodiment described below, a lifting mechanism is further provided with other components to increase the friction.

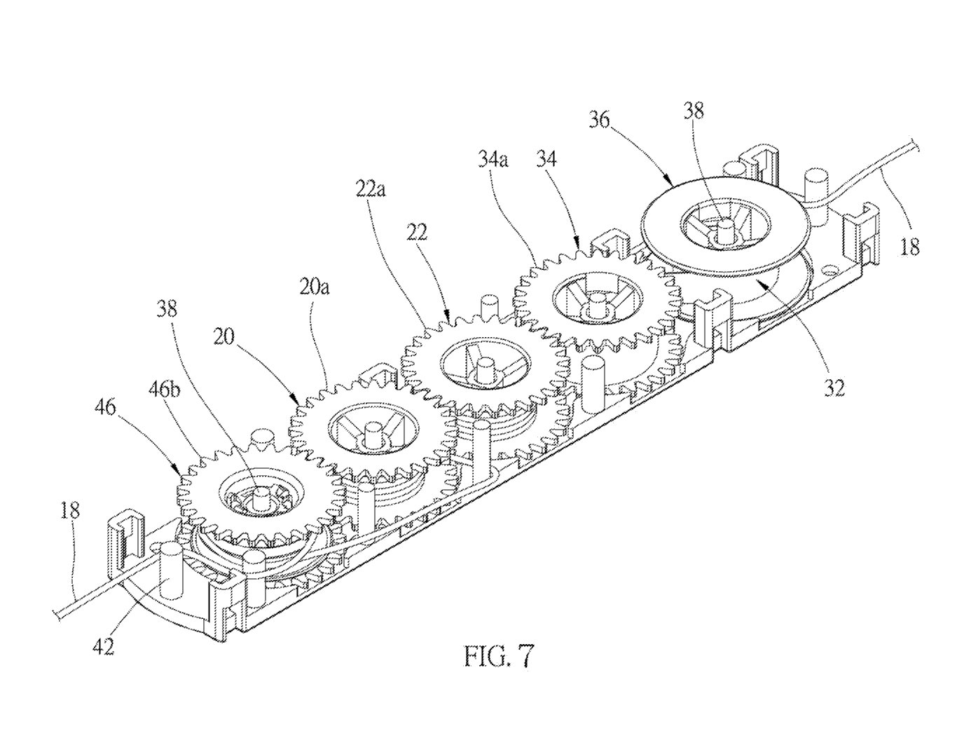

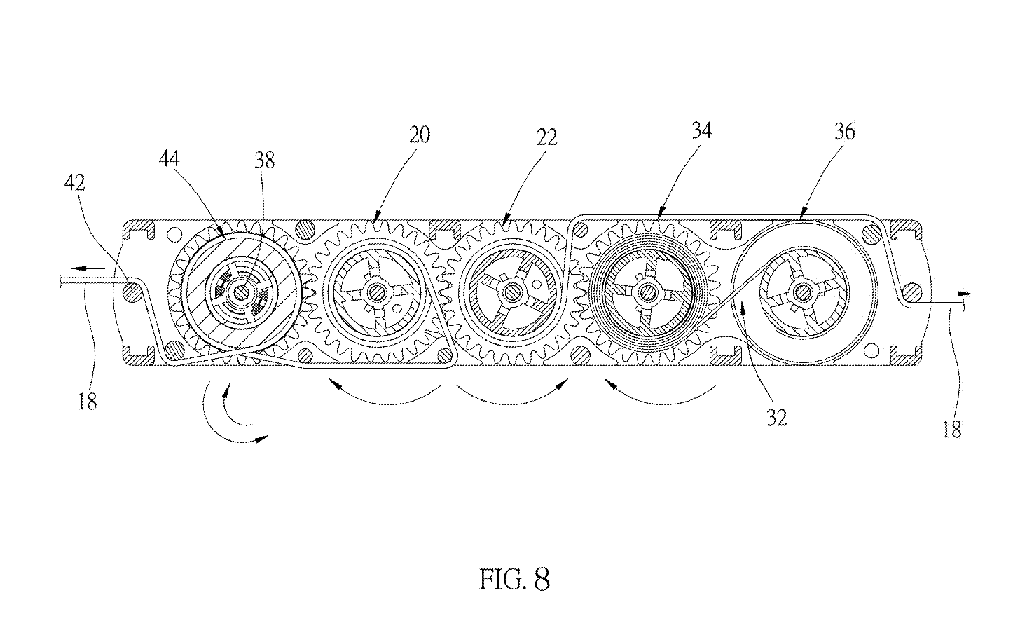

A lifting mechanism of a window covering of a second embodiment of the present invention is shown in FIG. 7 and FIG. 8, wherein the lifting mechanism is also provided in the first rail 10, and includes reels, friction wheels, and a prestress device, wherein the reels include the first reel 20 and the second reel 22 mentioned in the first embodiment, and the first reel 20 also has the first gear portions 20a, each of which meshes with one of the first gear portions 22a of the second reel 22. The prestress device, the same as the first embodiment, includes the spiral spring 32, the first rotor 34, and the second rotor 36, wherein the third gear portions 34a of the first rotor 34 mesh with the first gear portions 22a of the second reel 22 as well. Also, each of the first reel 20, the second reel 22, the first rotor 34 and the second rotor 36 also fits around the corresponding shaft 38, whereby to be provided on the base 40 in a rotatable manner.

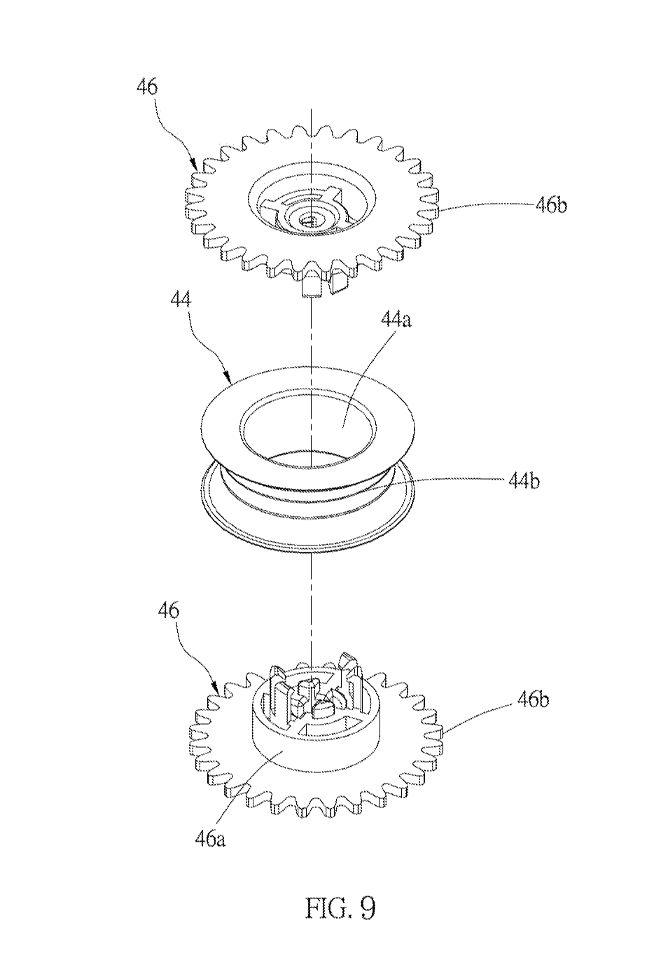

As shown in FIG. 9, the difference between the lifting mechanism of the second embodiment and that of the first embodiment is that the lifting mechanism of the current embodiment includes merely one single friction wheel 44, which has a shaft hole 44a being passed through by a shaft, wherein the shaft is also passed through by another one of the shafts 38, and is located adjacent to the first reel 20. In the current embodiment, the shaft passing through the shaft hole 44a of the friction wheel 44 is formed by correspondingly engaging two shaft components 46 in a detachable manner, wherein each of the shaft components 46 has a cylindrical body 46a passing through the shaft hole 44a, and has a second gear portion 46b, which is composed of a toothed disc, provided on an end thereof. Each of the second gear portions 46b meshes with one of the first gear portions 20a of the first reel 20. As mentioned above, the toothed discs are not limited to be provided on the top or the bottom; other positions would be also plausible. An inner surface of the shaft hole 44a of the friction wheel 44 is the first friction surface, and an outer surface of the cylindrical body 46a of each of the shaft components 46 is the second friction surface.

Another difference between the current embodiment and the previous embodiment is that, the window covering 100 of the first embodiment includes the direction changing members 28, 30 which are adapted to change the winding route of the lifting cords 18 so as to make each of the friction wheels 24, 26 contact the lifting cords 18 with at least half of the wheel surface thereof, while the window covering of the second embodiment omits these direction changing members. Instead, one of the lifting cords 18 winds a complete turn around the friction wheel 44. In the situation shown in FIG. 8, part of each of the lifting cords 18 still winds around the corresponding reel. When the second rail 12 is moved toward the low position PL to pull the lifting cords 18, the first reel 20 would be rotated clockwise to release one of the lifting cords 18, and the second reel 22 would be rotated counterclockwise to release the other one of lifting cords 18. At this time, the shaft components 46 would be rotated counterclockwise due to the meshing between the second gear portions 46b of the shaft components 46 and the first gear portions 20a of the first reel 20, while the friction wheel 44 would be driven by one of the released lifting cords 18 to be rotated clockwise. At the same time, said lifting cord 18 would apply the lateral pushing force F to the friction wheel 44, whereby to force the inner surface of the shaft hole 44a of the friction wheel 44 and the outer surface of the cylindrical body 46a of each of the shaft components 46 to contact each other. Since the friction wheel 44 and the shaft components 46 are rotated in opposite directions, there would be friction created therebetween.

With the aforementioned structural designs, the friction wheel 44 and the shaft components 46 would be driven by one of the lifting cords 18 to rotate in opposite directions, and said lifting cord 18 would apply the lateral pushing force F to the friction wheel 44. As a result, no matter whether the lifting cords 18 are being pulled out as the first rail 10 and the second rail 12 are being relatively moved away from each other, or is being reeled in as the first rail 10 and the second rail 12 are being relatively moved toward each other, the friction wheel 44 and the shaft components 46 would contact each other to create the friction therebetween. In this way, the second rail 12 would accurately stay at a required position. Therefore, the direction changing members can be omitted. However, some of the direction changing members 42 can be still provided to improve the smoothness while moving the lifting cords 18.

In the current embodiment, the friction wheel 44 is also provided with a cord slot 44b recessed into a circumferential surface of the cylindrical body thereof, whereby to retain the position of the corresponding lifting cord 18, and to adequately increase the friction between the friction wheel 44 and said lifting cord 18. Similarly, if the friction between the friction wheel 44 and said lifting cord 18 is already sufficient, with the help of the pulling force provided by the spiral spring 32, to properly and accurately position the second rail 12, the cord slots 44b can be omitted in other embodiments. In addition, though the current embodiment only includes one friction wheel (i.e. the friction wheel 44), another friction wheel can be further provided to be passed around by the other one of the lifting cords in other embodiments, whereby to create higher friction for window coverings of different sizes or styles.

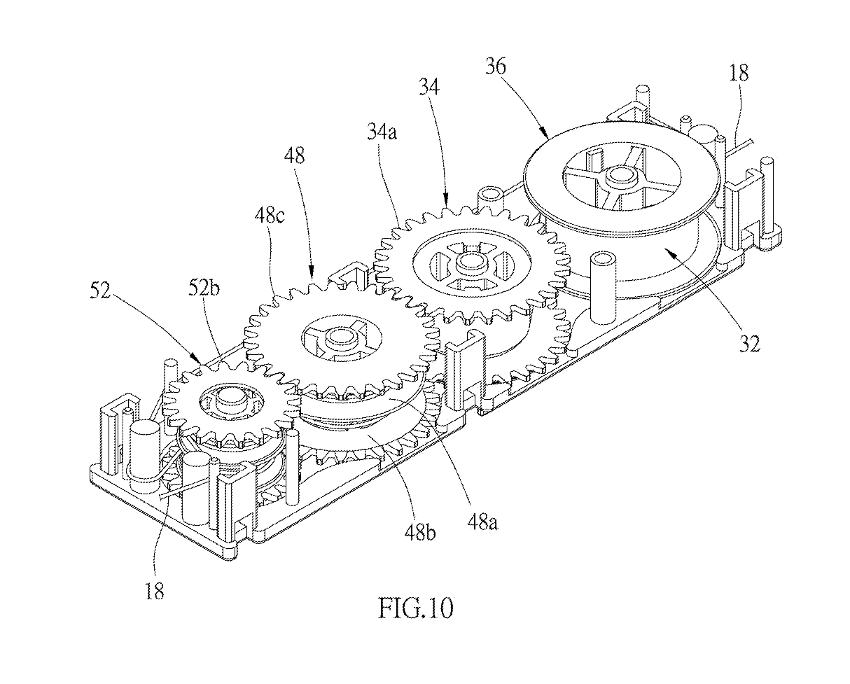

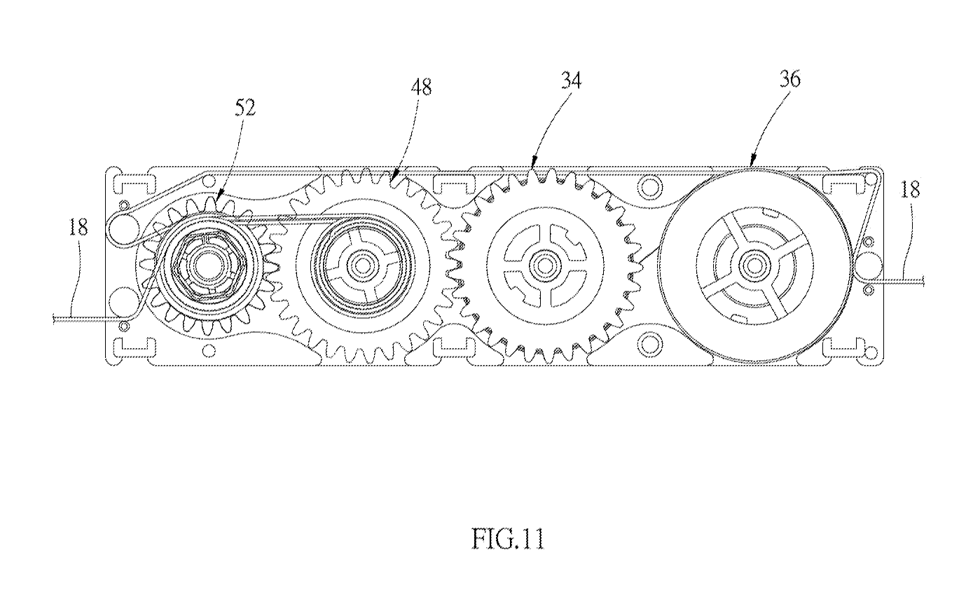

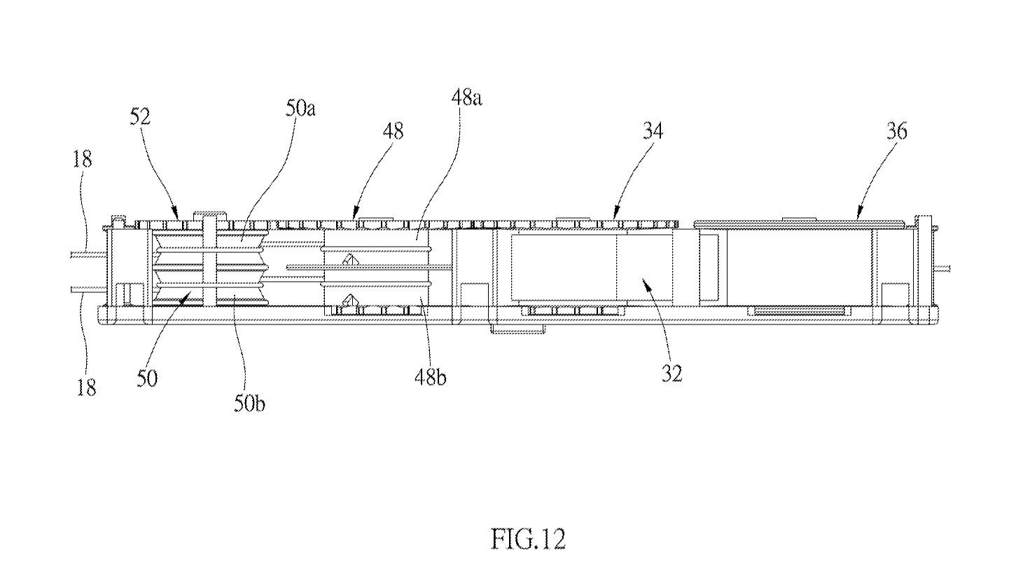

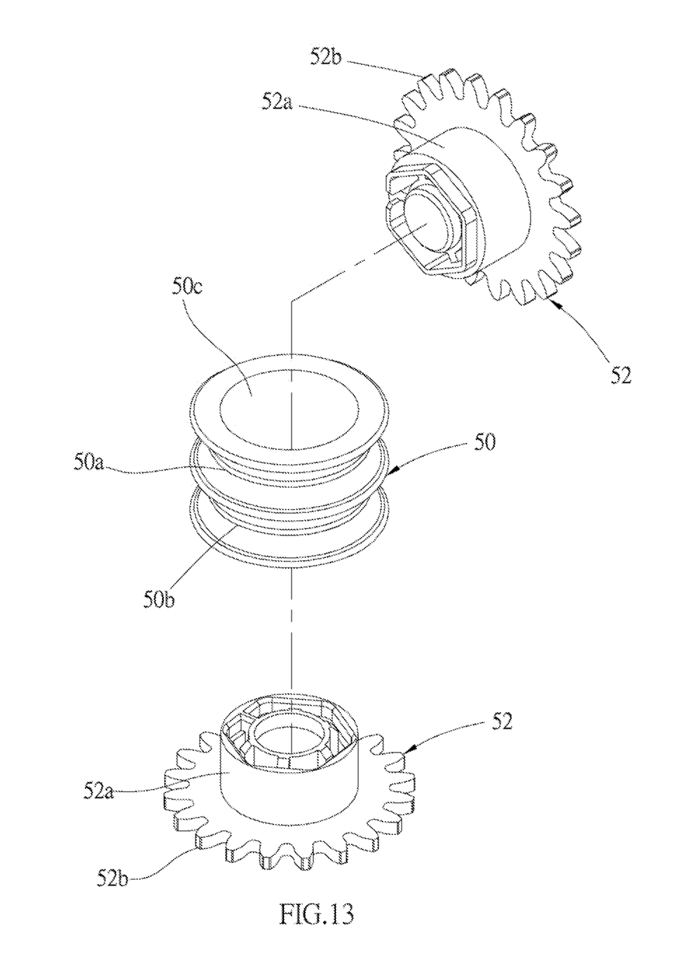

A lifting mechanism of a window covering of a third embodiment is shown in FIG. 10 to FIG. 12, which also includes the prestress device composed of the spiral spring 32, the first rotor 34, and the second rotor 36. The difference from the above embodiments is that a reeling device of the current embodiment has only one reel, and there is only one friction wheel as well. The reel 48 of the current embodiment has an upper reeling portion 48a and a lower reeling portion 48b in an axial direction thereof, each of which is respectively connected to an end of one of the lifting cords 18. At least an end of the reel 48 is provided with a first gear portion 48c, which is composed of a toothed disc, and meshes with the third gear portion 34a of the first rotor 34. As shown in FIG. 13, the friction wheel 50 of the current embodiment has an upper winding portion 50a and a lower winding portion 50b provided in an axial direction thereof, each of which is respectively wound around by one of the lifting cords 18. Similar to the second embodiment, the friction wheel 50 is passed through by a cylindrical body 52a of each of two shaft components 52 in a rotatable manner, wherein the shaft components 52 are correspondingly engaged with each other to form a shaft. Each of the shaft components 52 is a component provided with a second gear portion 52b, which is composed of a toothed disc, at an end thereof. Furthermore, at least one of the second gear portions 52b meshes with the at least one first gear portion 48c of the reel 48. Similarly, with the structures mentioned herein, when the at least one first gear portion 48c drives at least one of the second gear portions 52b to rotate, the lifting cords 18 would drive the friction wheel 50 and the shaft components 52 to rotate in opposite directions. As a result, an inner surface of the shaft hole 50c of the friction wheel 50 (i.e., the first friction surface) and the outer surface of each of the shaft components 52 (i.e., the second friction surface) would be moved in opposite directions to create the friction. Since the lifting mechanism of the current embodiment has only one reel and one friction wheel, the size of the lifting mechanism could be reduced to be easily installed in the first rail.

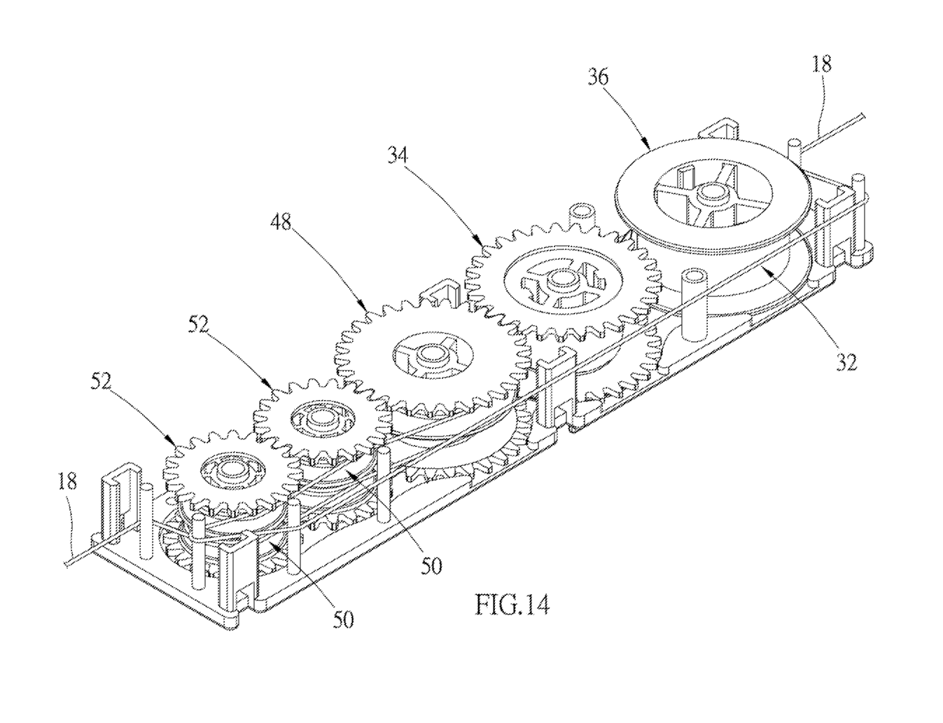

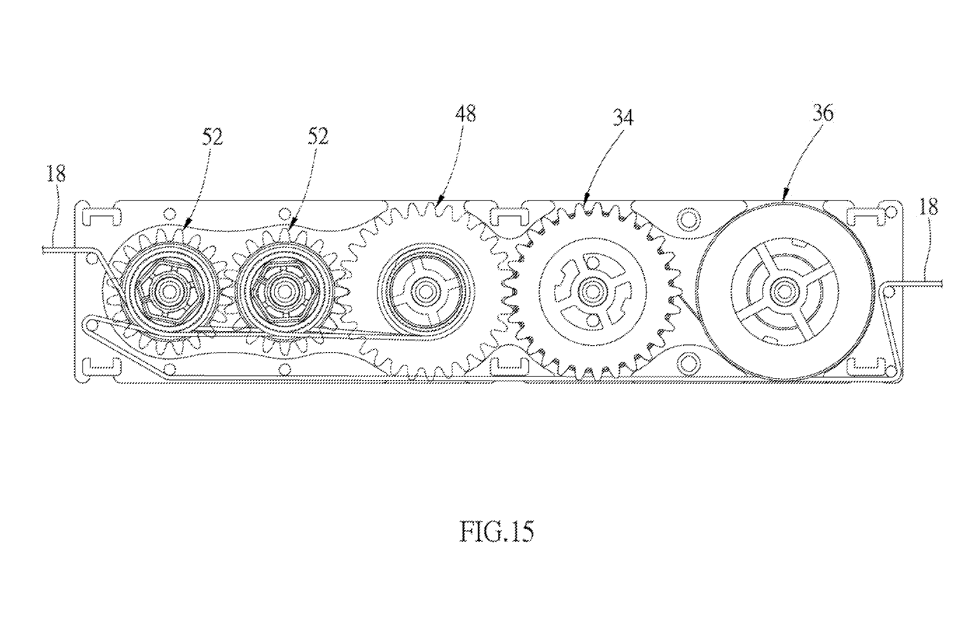

A lifting mechanism of a window covering of a fourth embodiment illustrated in FIG. 14 and FIG. 15 includes approximately the same components as the lifting mechanism of the aforementioned third embodiment, except that the lifting cords 18 wind around two friction wheels 50 at the same time. Each of the friction wheels 50 fits around two detachable shaft components 52, each of which has a second gear portion. Each two of the shaft components 52 are correspondingly engaged with each other to form a shaft, respectively. By providing more friction wheels 50, the lifting mechanism could provide higher friction, and therefore would be suitable for large window coverings.

In the lifting mechanisms of the aforementioned embodiments, the reels, the friction wheels, and the prestress devices are provided on the base together through shafts or shafts, and the reels and the friction wheels are separately arranged in parallel. However, in practice, the reels, the friction wheels, and the prestress devices are not limited to be disposed on the base together. For example, at least one among the reels, the friction wheels, or the prestress device could be also respectively or collaboratively disposed on a seat in other embodiments. In other words, the lifting mechanism could be designed and used with more flexibility.

It is worth mentioning that, in each of the aforementioned embodiments, the gear ratio of each of first gear portions and the corresponding second gear portion is 1, but this is not a limitation of the present invention. To meet different requirements, the gear ratio of one first gear portion and one second gear portion can be other than 1. In other words, by meshing a first gear portion with a second gear portion which have different numbers of teeth, the rotation speed of the first gear portion can be different form that of the second gear portion, whereby the friction could be modulated. In addition, the friction wheels and the reels included in a lifting mechanism are not limited to have the same outside diameter. For example, one friction wheel could have a first diameter, and one reel can have a second diameter other than the first diameter. By changing the combination of the different first and second diameters, the friction could be also modulated.

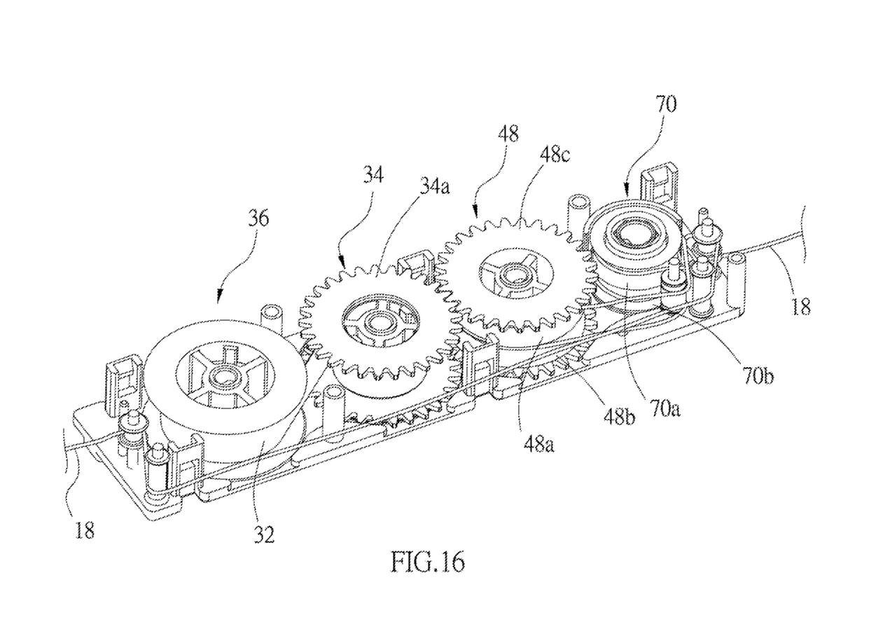

A lifting mechanism of a window covering of a fifth embodiment of the present invention is illustrated in FIG. 16 to FIG. 17, which is similar to the lifting mechanism shown in FIG. 10, and also has the prestress device composed of the spiral spring 32, the first rotor 34, and the second rotor 36. The reeling device of the current embodiment has only one reel, and there is only one friction wheel, too. In the current embodiment, the reel 48 has an upper reeling portion 48a and a lower reeling portion 48b provided in an axial direction thereof, each of which is connected to an end of one of the lifting cords 18. At least an end of the reel 48 is provided with a first gear portion 48c, which is composed of a toothed disc. The at least one first gear portion 48c meshes with at least one of the third gear portions 34a of the first rotor 34.

As shown in FIG. 16, the friction wheel 70 of the present invention includes an upper winding portion 70a and a lower winding portion 70b provided in an axial direction thereof, each of which is wound around by one of the lifting cords 18. The friction wheel 70 is passed through by a cylindrical body of a shaft 58 in a rotatable manner. As shown in FIG. 17, the shaft 58 has a non-circular shaft hole 58c, which is a hexagonal hole as an example. Furthermore, the non-circular shaft hole 58c matches with a non-circular rod (e.g., a hexagonal rod, not shown) of the base, so that the shaft 58 fitting around the non-circular rod cannot be rotated relative to the base. Therefore, through the driving of the lifting cords 18, the friction wheel 70 could be rotated relative to the shaft 58. In addition, since the lifting cords 18 would apply the lateral pushing force to the friction wheel 70, there would be friction created when the friction wheel 70 is rotated relative to the shaft 58.

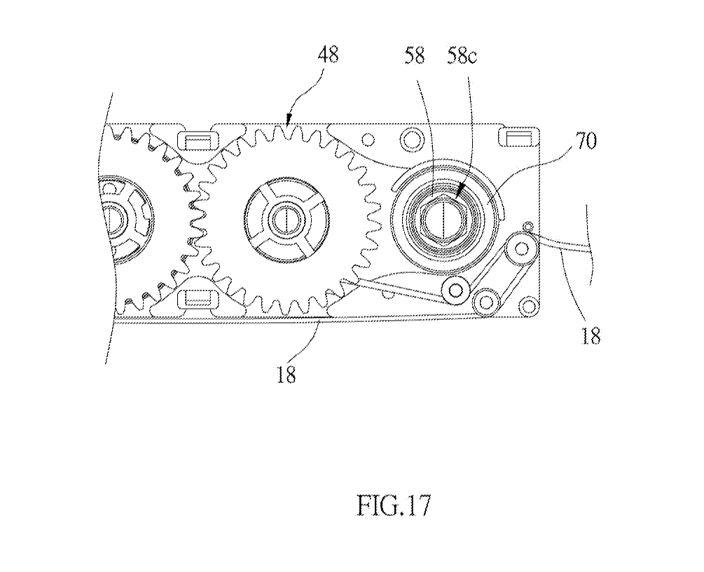

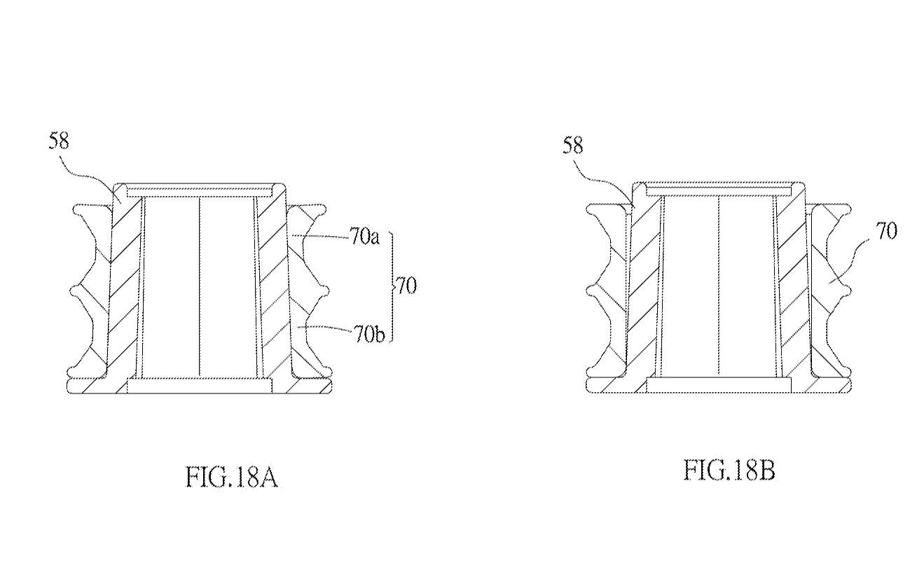

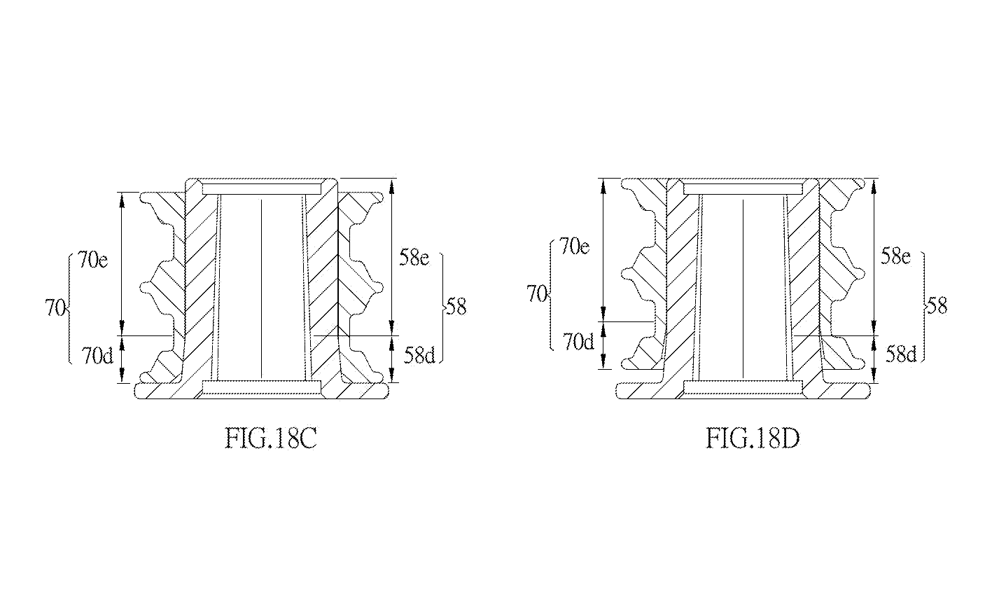

The friction wheel 70 and the shaft 58 in the current embodiment may have various variants in practice. Two types of variants are illustrated in FIGS. 18A and 18B, which are sectional views showing how the friction wheel 70 fitting around the shaft 58. As shown in FIG. 18A, the shaft 58 could be a hollow flat top cone. In other words, an outside diameter of a lower part of the shaft 58 is greater than an outside diameter of an upper part thereof, wherein the lower power can be deemed a first axial portion, and the upper part can be deemed a second axial portion. Furthermore, an inside diameter of the friction wheel 70 also matches with a contour of the shaft 58, which means, the inside diameter of a lower part of the friction wheel 70 is greater than the inside diameter of an upper part thereof, wherein the inside diameter of the lower part can be deemed a first inside diameter, and the inside diameter of the upper part can be deemed a second inside diameter. In addition, a height of the shaft 58 is greater than a height of the friction wheel 70, whereby the friction wheel 70 could be moved up and down in an axial direction of the shaft 58. When the friction wheel 70 is located at a lower part of the shaft 58, a contact area between an inner wall of the friction wheel 70 and an outer wall of the shaft 58 would be larger, and therefore the friction created therebetween would be higher; on the contrary, when the friction wheel 70 is located at an upper part of the shaft 58, the contact area between an inner wall of the friction wheel 70 and an outer wall of the shaft 58 would be smaller, creating less friction.

Another type of variants of the friction wheel 70 and the shaft 58 is illustrated in FIGS. 18C and 18D, showing that the shaft 58 could be a hollow rod as well, wherein the shaft 58 includes a flat-topped conical segment 58d, which can be deemed a first axial portion, and a cylindrical segment 58e, which can be deemed a second axial portion. The cylindrical segment 58e has a uniform outside diameter, while an end of the flat-topped conical segment 58d has a smaller outside diameter than another end thereof. The cylindrical segment 58e is connected to one of the ends of the flat-topped conical segment 58d which has the smaller outside diameter. The friction wheel 70 includes an oblique segment 70d and a uniform segment 70e, wherein the uniform segment 70e has a uniform inside diameter, while an end of the oblique segment 70d has a smaller inside diameter than another end thereof. The uniform segment 70e is connected to the end of the oblique segment 70d which has the smaller inside diameter. The inside diameter of the oblique segment 70d, which can be deemed a first inside diameter, is greater or equal to the inside diameter of the uniform segment 70e, which can be deemed a second inside diameter. The inside diameter of the uniform segment 70e of the friction wheel 70 matches with the outside diameter of the cylindrical segment 58e of the shaft 58, so that the friction wheel 70 could be steadily rotated about the shaft 58 and moved up and down along the shaft 58 without shaking or tilting. In more details, as shown in FIG. 18C, when the friction wheel 70 is located at a lower part of the shaft 58, the inner wall of the oblique segment 70d of the friction wheel 70 would contact the outer wall of the flat-topped conical segment 58d of the shaft 58, and the inner wall of the uniform segment 70e of the friction wheel 70 would contact the outer wall of the cylindrical segment 58e of the shaft 58, whereby the friction created between the friction wheel 70 and the shaft 58 would be higher; on the contrary, as shown in FIG. 18D, when the friction wheel 70 is located at an upper part of the shaft 58, the inner wall of the oblique segment 70d of the friction wheel 70 would be slightly separated from the outer wall of the flat-topped conical segment 58d of the shaft 58. At this time, the inner wall of the uniform segment 70e of the friction wheel 70 and the outer wall of the cylindrical segment 58e of the shaft 58 would be the only contacted part between the friction wheel 70 and the shaft 58. As a result, the friction created therebetween would be less.

Similar friction modulation could also be achieved through the combination of the friction wheel 70 and the shaft 58 illustrated in FIG. 18B, wherein the shaft 58 in FIG. 18B is structurally the same with that shown in FIG. 18A, but the friction wheel 70 in FIG. 18B has a uniform inside diameter. Therefore, when the friction wheel 70 fits around the shaft 58, a bottom inner edge of the friction wheel 70 would contact the shaft 58, and a top inner edge of the friction wheel 70 would be separated from the shaft 58. In addition, a height of the shaft 58 is also greater than that of the friction wheel 70, so that the friction wheel 70 could be moved up and down in an axial direction of the shaft 58. When the friction wheel 70 is located at a lower part of the shaft 58, a contact area between the bottom inner edge of the friction wheel 70 and an outer wall of the shaft 58 would be larger, and therefore, the friction created between the friction wheel 70 and the shaft 58 would be higher; on the contrary, when the friction wheel 70 is located at an upper part of the shaft 58, the contact area between the bottom inner edge of the friction wheel 70 and the outer wall of the shaft 58 would be smaller, creating less friction therebetween.

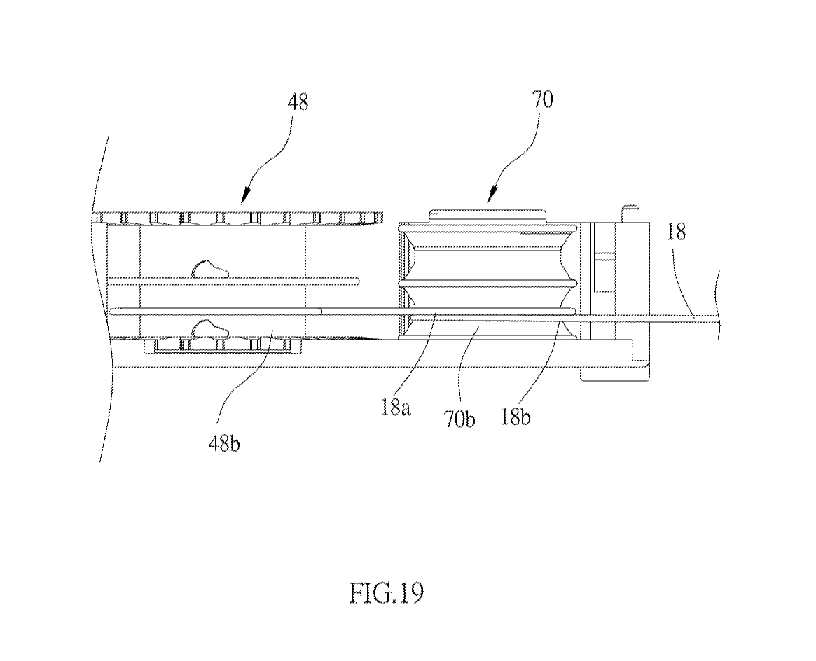

It is worth noting that, in the current embodiment, the friction wheel 70 could be moved up and down in the axial direction of the shaft 58 in accordance with a specific winding direction of the corresponding lifting cord 18 around the friction wheel 70, whereby the strength of the friction could be modulated. As shown in FIG. 19, the corresponding lifting cord 18 winds a complete turn around the lower winding portion 70b of the friction wheel 70, wherein said lifting cord 18 has a first cord segment 18a, which can be deemed an inward cord segment, connected to the lower reeling portion 48b of the reel 48, and a second cord segment 18b, which can be deemed an outward cord segment, connected to the second rail 12. In addition, said lifting cord 18 winds around the friction wheel 70 from top down in a counterclockwise direction, so that the first cord segment 18a of the lifting cord 18 is always above the second cord segment 18b. In other words, the first cord segment is closer to a top edge of the friction wheel than the second cord segment is, wherein the top edge of the friction wheel which can be deemed a first end. Whereby, when the second rail 12 is pulled down so as to pulling the second cord segment 18b of the aforementioned lifting cord 18 away from the friction wheel 70, the friction wheel 70 would be moved along the shaft 58 toward the top edge of the friction wheel 70, and the friction at this time would be less; on the contrary, when the second rail 12 is pushed upward, the friction wheel 70 would be driven to move toward the lower part of the shaft 58 due to the winding direction of said lifting cord 18 around the friction wheel 70, whereby to create higher friction.

In other embodiments of the present invention, the friction wheel 70 has a cord slot provided around a cylindrical body of the upper winding portion and the lower winding portion, wherein the cord slot is recessed into a circumferential surface of the cylindrical body. In one embodiment, the cord slot is helical. The cord slot receives part of one of the lifting cords 18 therein. In addition to stabilizing the position of the corresponding lifting cord 18, the cord slot would also create higher friction, for slot walls of the cord slot 24b enlarges a contact area for the corresponding lifting cord 18. Such design would also enhance the effect of driving the friction wheel 70 to move up and down along the shaft 58 through the specific winding direction of the relevant lifting cord 18 around the friction wheel 70. Of course, if the friction created through the abutting between the friction wheel 70 and the shaft 58 is, with the help of the pulling force provided by the spiral spring, already sufficient to properly and accurately position the second rail, then the cord slot can be omitted in other embodiments.

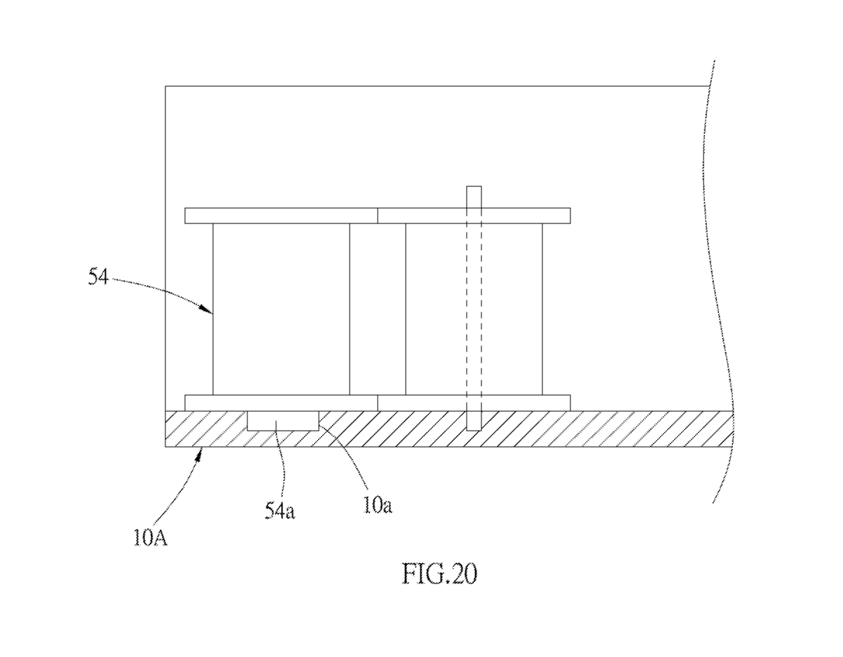

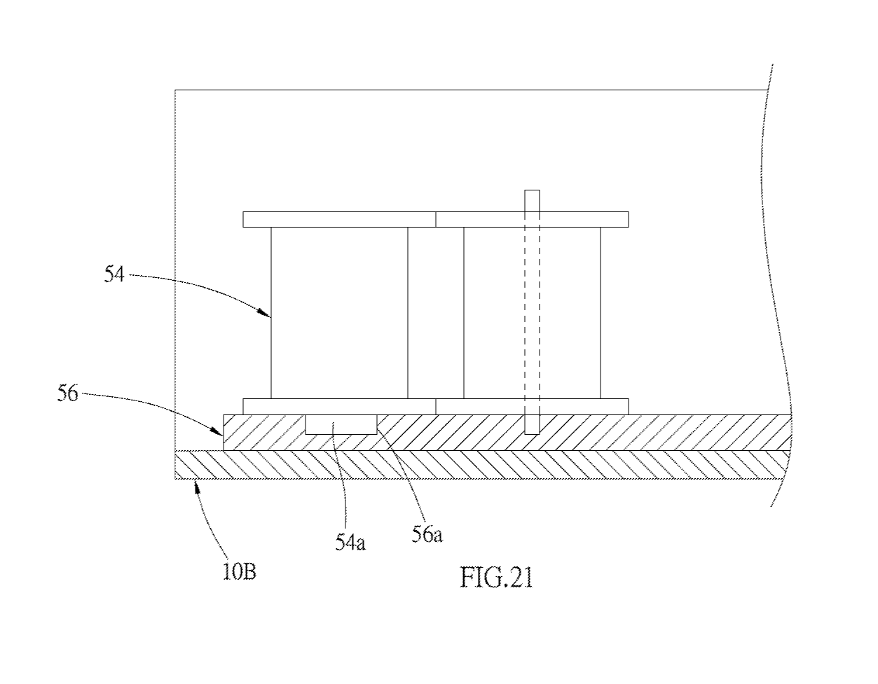

In the aforementioned embodiments, the friction is created by making the inner surface of the shaft hole of the friction wheel contact the outer surface of the shaft (i.e., the rubbed member) which has a toothed disc at an end thereof, and moving these two components in opposite directions. However, in practice, the rubbed member is not limited to be a shaft with a toothed disc. A sixth embodiment and a seventh embodiment of the present invention are two examples, which are illustrated respectively in FIG. 20 and FIG. 21. The rubbed member shown in FIG. 20 is a recess 10a on the first rail 10A, wherein the friction wheel 54 has a projection 54a on an axial center thereof, and the projection 54a corresponds to and fits into the recess 10a. The rubbed member shown in FIG. 21 is a casing 56, which in part of the first rail 10B, and has a recess 56a provided thereon, wherein the projection 54a of the friction wheel 54 corresponds to and fits into the recess 56a. In the embodiments shown in FIG. 20 and FIG. 21, the outer surface of the projection 54a of the friction wheel 54 is the first friction surface, and the inner surface of the recess is the second friction surface. When the friction wheel 54 is driven by the corresponding lifting cord to rotate, said lifting cord would apply a lateral pushing force on the friction wheel 54, whereby the projection 54a of the friction wheel 54 would abut against the recess, and therefore the friction could be created between the outer surface of the projection and the inner surface of the recess.

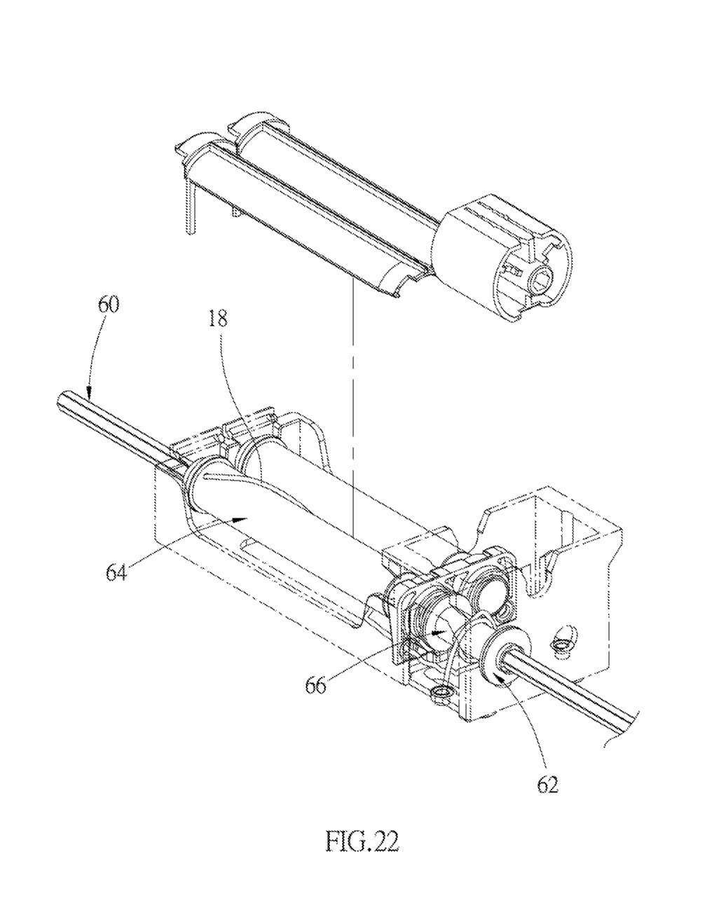

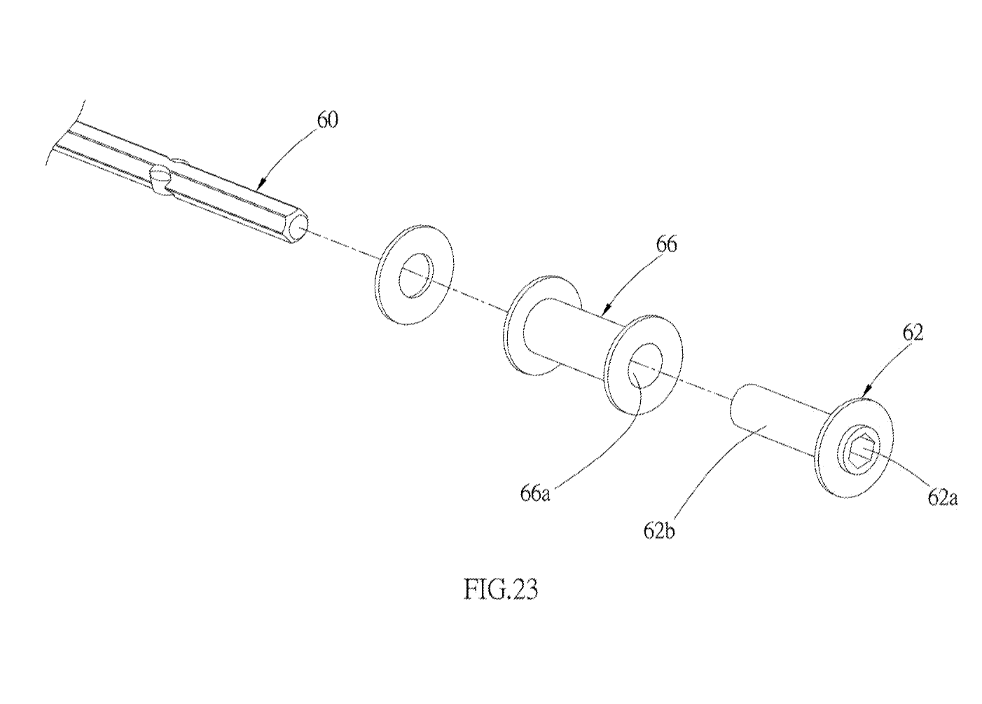

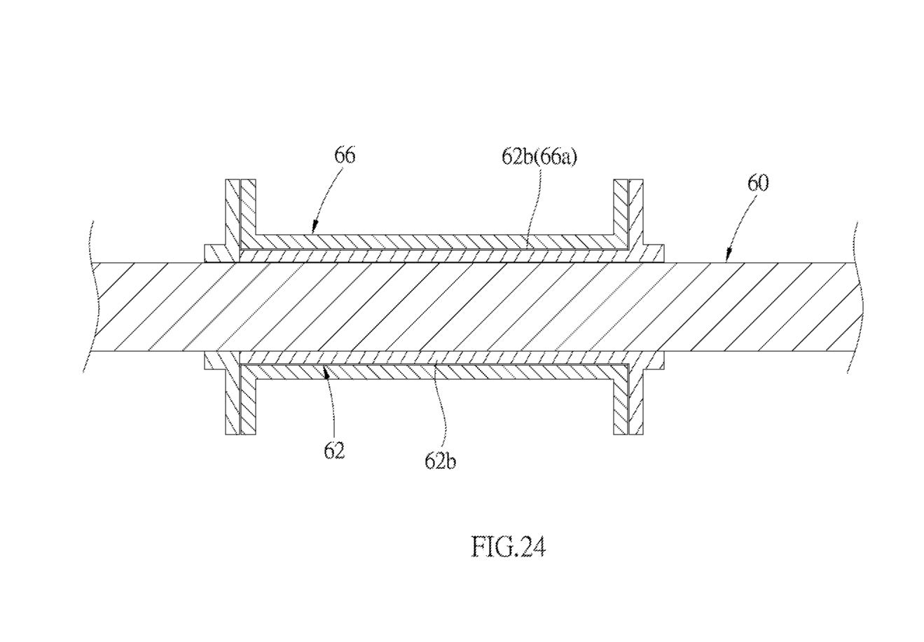

In addition, an eighth embodiment of the present invention is illustrated in FIG. 22 to FIG. 24, wherein the shaft includes a post 60 and a sleeve 62. The post 60 is a polygonal column, and passes through a polygonal hole 62a of the sleeve 62, so that the sleeve 62 could be rotated along with the post 60. Also, the post 60 passes through a reel 64, which matches with the post 60 in such a manner that the reel 64 is rotatable along with the post 60. Furthermore, a friction wheel 66 fits around a tubular body 62b of the sleeve 62, wherein the friction wheel 66 and the reel 64 are provided coaxially. An inner surface of the shaft hole 66a of the friction wheel 66 is a first friction surface, and an outer surface of the tubular body 62b is a second friction surface. Similarly, when the corresponding lifting cord 18 drives the friction wheel 66 to rotate, the lifting cord 18 would apply a lateral pushing force to the friction wheel 66, whereby the friction wheel 66 would abut against the sleeve 62, and therefore the friction could be created between the friction wheel 66 and the sleeve 62.

It must be pointed out that the embodiments described above are only some embodiments of the present invention. All equivalent structures which employ the concepts disclosed in this specification and the appended claims should fall within the scope of the present invention.

What is claimed is:

1. A window covering, comprising:
a first rail;
a second rail;
a shielding structure provided between the first rail and the second rail; and
a lifting mechanism provided in the first rail, wherein the lifting mechanism comprises a cord, a reeling device, a friction wheel, and a rubbed member; an end of the cord is connected to the reeling device, and another end thereof is connected to the second rail; the cord passes around and contacts the friction wheel; the friction wheel matches with the rubbed member;
wherein, while the first rail and the second rail are being moved to approach each other, the shielding structure is being closed, and the reeling device is reeling in the cord; while the first rail and the second rail are being moved away from each other, the shielding structure is being opened, and the reeling device is releasing the cord; when the first rail and the second rail are moved toward or away from each other, the cord drives the friction wheel to rotate, and the cord applies a lateral pushing force to the friction wheel, making the friction wheel abut against the rubbed member, whereby to create a friction between the friction wheel and the rubbed member.

2. The window covering of claim 1, wherein the friction wheel has a first friction surface, and the rubbed member has a second friction surface; the first friction surface corresponds to the second friction surface; the first friction surface and the second friction surface contact each other due to the lateral pushing force, whereby to create the friction.

3. The window covering of claim 2, wherein the rubbed member is a shaft, and the friction wheel has a shaft hole; the shaft passes through the shaft hole of the friction wheel; an outer surface of the shaft is the second friction surface, and an inner surface of the shaft hole of the friction wheel is the first friction surface.

4. The window covering of claim 3, wherein the cord drives the friction wheel and the shaft to rotate in opposite directions; when the cord applies the lateral pushing force to the friction wheel, and when a rotation of the reel drives the shaft to rotate, the first friction surface and the second friction surface contact each other and move in opposite directions, whereby to create the friction.

5. The window covering of claim 3, wherein the reeling device comprises a reel, which comprises a first gear portion; at least one end of the shaft has a second gear portion provided thereon, wherein the second gear portion rotates synchronously and simultaneously with the shaft; the first gear portion and the second gear portion drive each other; a rotation direction of the friction wheel and a rotation direction of the shaft driven by the cord are opposite; when the first gear portion and the second gear portion drive each other, the first friction surface of the friction wheel and the second friction surface of the shaft are moved in opposite directions, whereby to create the friction.

6. The window covering of claim 5, wherein a gear ratio of the first gear portion and the second gear portion is not 1; when the cord drives the friction wheel, a rotation speed of the first gear portion is different from a rotation speed of the second gear portion, whereby to modulate the friction.

7. The window covering of claim 5, wherein the shaft comprises a post and a sleeve fitting around the post; the friction wheel fits around the sleeve; an outer surface of the sleeve is the second friction surface, and an inner surface of the shaft hole of the friction wheel is the first friction surface.

8. The window covering of claim 2, wherein the rubbed member is a recess of the first rail, and the friction wheel has a projection provided on an axial center thereof, which corresponds to and fits into the recess; an outer surface of the projection is the first friction surface, and an inner surface of the recess is the second friction surface.

9. The window covering of claim 2, wherein the first rail further comprises a casing, and the lifting mechanism is provided in the casing; the rubbed member is a recess of the casing, and the friction wheel has a projection provided on an axial center thereof; an outer surface of the projection is the first friction surface, and an inner surface of the recess is the second friction surface.

10. The window covering of claim 3, wherein the shaft comprises a first axial portion and a second axial portion, and an outside diameter of the first axial portion is greater than an outside diameter of the second axial portion; the shaft passes through the shaft hole of the friction wheel; an outer surface of the shaft is the second friction surface, and an inner surface of the shaft hole of the friction wheel is the first friction surface.

11. The window covering of claim 10, wherein the shaft hole of the friction wheel is a first inside diameter and a second inside diameter, and the first inside diameter is greater than the second inside diameter.

12. The window covering of claim 10, wherein a height of the shaft is greater than a height of the friction wheel, and a movement of the cord drives the friction wheel to move in an axial direction of the shaft; when the friction wheel is moved in the axial direction of the shaft from the first axial portion toward the second axial portion, a contact area between the first friction surface and the second friction surface becomes smaller, whereby to gradually reduces the friction created between the friction wheel and the shaft.

13. The window covering of claim 12, wherein a cord segment of the cord which winds a complete turn around the friction wheel comprises an inward cord segment and an outward cord segment; the inward cord segment is closer to a first end of the friction wheel than the outward cord segment is; when the cord is pulled with the outward cord segment thereof, the friction wheel is driven to move toward the first end along the shaft.

14. The window covering of claim 1, wherein the friction wheel has a first diameter, and the reeling device comprises a reel, which has a second diameter; the first diameter is different from the second diameter; when the cord drives the friction wheel to rotate, a rotation speed of the friction wheel is different from a rotation speed of the reel, whereby to modulate the friction.

15. The window covering of claim 1, wherein the friction wheel has a cord slot recessed into a circumferential surface of the friction wheel; the cord passes around and contacts the cord slot of the friction wheel.

16. The window covering of claim 1, wherein the reeling device comprises a reel, which has a shaft; the rubbed member is another shaft, and the friction wheel fits around the another shaft; the shaft and the another shaft are separately arranged in parallel.

17. The window covering of claim 1, wherein the reeling device comprises a reel, which is provided coaxially with the friction wheel.
